(19) United States
(12) Patent Application Publication
(10) Pub. No.: US 2002/0078905 A1
(43) Pub. Date: Jun. 27, 2002

(54) Doxie duds

(76) Inventor: Janet G. Wilson, Napa, CA (US)

Correspondence Address: Janet G. Wilson, 154 Garth St., Napa, CA, 94558, US

(21) Appl. No.: 09/976,629

(22) Filed: Oct. 13, 2001

Related U.S. Application Data
(60) Provisional application No. 60/240,149, filed on Oct. 13, 2000.

(51) Int. Cl. A01K 13/00

(52) U.S. Cl. 119/850

(57) ABSTRACT

Improved style of dog clothes for the Dachshund breed will contribute to the comfort & warmth of the Dachsies and make it easier for the owners to obtain a correctly fitted/sized garment. This is easily made with only 2 simple pattern pieces.

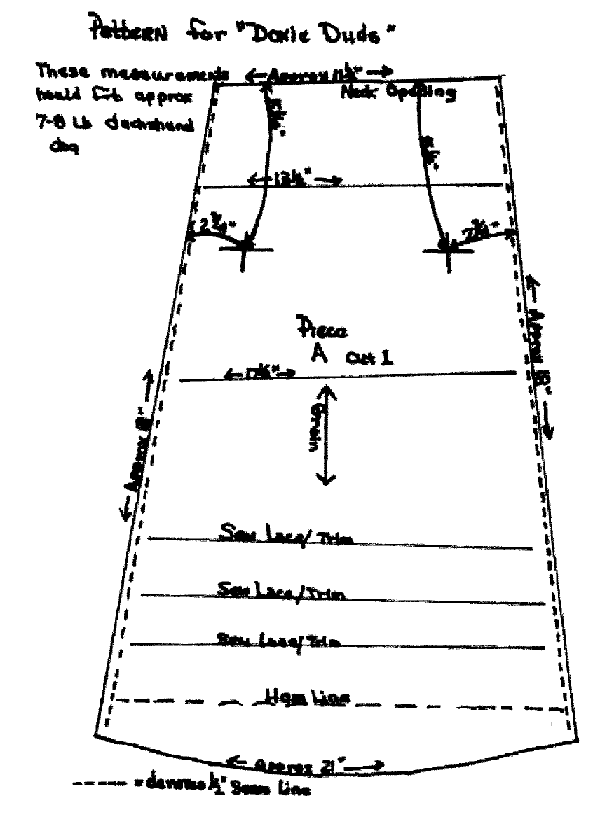

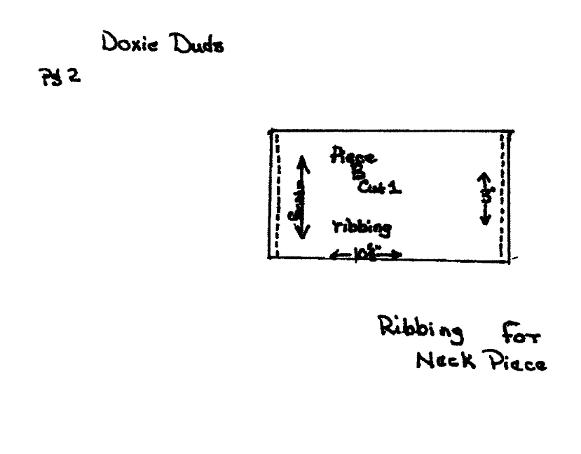

### DIRECTIONS FOR MAKING “DOXIE DUDS”

Before getting started, you need the dog's measurements. You will need. Underside, distance from neck to front legs Size around neck. Distance between front legs. Size around legs up next to body Size around chest at largest part. Length of dog Size around hips for elastic

1. Cut 1 piece using pattern piece “A”. Adjust to fit different sizes by adding to or lessening width along both sides. The material I usually use is flannel, lightweight fleece, & “sweatshirt” material. Also, T-Shirt knits could be used. I am going to try using a regular cotton and see if it works, but I think it's better if material has a little “give” or stretch to it.

2. Cut 1 piece using pattern piece “B”. It should be approx 1½ inch smaller than neck opening on piece “A”. Use “ribbing” material, sew together to form “tube” shape.

3. Measure and cut 2 leg holes approx 2¾ inches in from each side of piece “A”. I draw 2 lines, 1 horozontal (1½Δ long) and 1 vertical (2¾″ long) in a +or × shape. Next, fold to inside the little “flaps” of these cuts and tack down, leaving opening for legs.

4. Sew on desired trim, using lace, rick-rack, eyelet, etc. to piece “A”, while it is still flat. I usually sew 3 rows, but it can be more or less as desired.

5. Sew together side seams, entire length to form “tube” shape.

6. Sew casing for elastic and hem, leaving opening to insert elastic. Legnth can be adjusted according to length of dog or length desired. A shorter version might be more appropriate for a male dog.

7. Cut elastic and insert. Sew opening closed after inserting. Remember that you don't want this to be too tight and uncomfortable for the dog.

8. Slip piece “B” down over piece “A” so that right sides of both pieces are together. Line up seams from both pieces so they are together also. Sew together, stretching to fit as you sew.

9. Turn outfit inside out, fold ribbing over to inside edge, overlaping first seam slightly and sew, stretching to fit as you sew.

10. Turn back to right side out and you're finished.

1. This garment, with minor measurement adjustments can be made to fit all sizes of Dachshunds.
